(19) United States
(12) Patent Application Publication
(10) Pub. No.: US 2006/0079248 A1
(43) Pub. Date: Apr. 13, 2006

(54) Mobile communication terminal and position information using method

(75) Inventors: Takayuki Otsuka, Yokohama-shi (JP); Hiroyuki Menjo, Mito-shi (JP); Katsutoshi Murata, Kunitachi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 11/238,966

(22) Filed: Sep. 30, 2005

(30) Foreign Application Priority Data
Oct. 8, 2004 (JP) 2004-296585

(51) Int. Cl. H04Q 7/20

(52) U.S. Cl. 455/456.1; 455/404.2

(57) ABSTRACT

An object of the present invention is to provide a cell phone capable of using base station position information and GPS position information more appropriately. This cell phone 10 is provided with a first position acquirer 12 for acquiring first position information of cell phone 10 calculated using a position of at least one base station under which the cell phone 10 is placed, a second position acquirer 13 for acquiring second position information of cell phone 10, using the global positioning system, an accuracy comparator 14 for making a comparison between respective accuracies of the first position information and the second position information, and a position information using part 15 for selectively using the first position information or the second position information in accordance with the result of the comparison; the position information using part 15 first uses the first position information, irrespective of the result of the comparison made by the accuracy comparator 14, and thereafter uses position information with higher accuracy out of the first position information and the second position information in accordance with the result of the comparison made by the accuracy comparator 14.

### BACKGROUND OF THE INVENTION

1. Field of the Invention

The present invention relates to a mobile communication terminal and a position information using method.

2. Related Background of the Invention

There are mobile communication terminals configured to acquire position information and to provide geographical information. The position information acquired by the mobile communication terminals is classified under base station position information and GPS position information. The base station position information is position information calculated using base stations under communication with a mobile communication terminal in a mobile communication network to which the mobile communication terminal belongs. The GPS position information is position information acquired using the global positioning system (GPS). In general, the GPS position information requires more time than the base station position information.

Patent Document 1 discloses the technology in which the mobile communication terminal first displays the base station position information acquired earlier and then switches the display to the GPS position information upon acquisition of the GPS position information later on.
[Patent Document 1]Japanese Patent Application Laid-Open No. 2003-284121

### SUMMARY OF THE INVENTION

The technology described in above Patent Document 1 is premised on the assumption that the GPS position information requiring more time for acquisition has higher accuracy than the base station information. However, the Inventors found the following phenomenon as a result of investigation. For example, in the urban area or the like, the accuracy of the GPS position information is low because of a small number of satellites outputting signals that can be received by mobile communication terminals. On the other hand, the number of mobile communication terminals used is large in the urban area or the like, and the accuracy of the base station position information is high because of a large number of base stations relative to the size of the urban area. Therefore, the Inventors discovered that the accuracy of the GPS position information is sometimes lower than the accuracy of the base station position information in the urban area or the like.

An object of the present invention is therefore to provide a mobile communication terminal capable of using the base station position information and the GPS position information more appropriately.

A mobile communication terminal according to the present invention is a mobile communication terminal comprising: first position acquiring means for acquiring first position information of the mobile communication terminal calculated using a position of at least one base station under which the mobile communication terminal is placed; second position acquiring means for acquiring second position information of the mobile communication terminal, using the global positioning system; accuracy comparing means for making a comparison between respective accuracies of the first position information and the second position information; and position information using means for selectively using the first position information or the second position information in accordance with a result of the comparison; wherein the position information using means first uses the first position information, irrespective of the result of the comparison made by the accuracy comparing means, and, thereafter, uses position information with higher accuracy out of the first position information and the second position information in accordance with the result of the comparison made by the accuracy comparing means.

A position information using method of the present invention is a position information using method comprising: a step wherein first position acquiring means acquires first position information of a mobile communication terminal calculated using a position of at least one base station under which the mobile communication terminal is placed; a step wherein second position acquiring means acquires second position information of the mobile communication terminal, using the global positioning system; a step wherein accuracy comparing means makes a comparison between respective accuracies of the first position information and the second position information; a step wherein position information using means selectively uses the first position information or the second position information in accordance with a result of the comparison; and a step wherein the position information using means first uses the first position information, irrespective of the result of the comparison made by the accuracy comparing means, and, thereafter, uses position information with higher accuracy out of the first position information and the second position information in accordance with the result of the comparison made by the accuracy comparing means.

Since in the mobile communication terminal and the position information using method of the present invention the accuracy comparing means makes the comparison between the respective accuracies of the first position information and the second position information, it is feasible to securely find out which accuracy is higher between the first position information and the second position information. Since the position information using means is arranged first to use the first position information, irrespective of the result of the comparison between the accuracies, and thereafter to use the position information with higher accuracy out of the first position information and the second position information in accordance with the result of the comparison between the accuracies, it is feasible first to use the first position information that can be easily acquired, and thereafter to use the position information with higher accuracy in accordance with the result of the comparison between the accuracies.

In the mobile communication terminal of the present invention, preferably, each of the first position information and the second position information contains error information indicating a horizontal error, and the accuracy comparing means makes the comparison between the accuracies on the basis of the error information contained in each of the first position information and the second position information. Since the comparison between the accuracies is made based on the error information indicating the horizontal error, it is feasible to make quantitative comparison between the accuracy of the first position information and the accuracy of the second position information.

In the mobile communication terminal of the present invention, preferably, when a horizontal error of the first position information indicated by error information contained in the first position information is within a predetermined error, the second position acquiring means does not acquire the second position information. Since the acquisition of the second position information is not carried out when the horizontal error of the first position information is within the predetermined error, it is feasible to eliminate the time necessary for acquisition of the second position information when the first position information is obtained with the accuracy over a predetermined level.

In the mobile communication terminal of the present invention, preferably, when the base station used in calculation of the first position information is a specific base station, the first position information contains information about the specific base station, and the second position acquiring means does not acquire the second position information. When it is known in advance that it is infeasible to acquire the second position information with a higher accuracy than that of the first position information calculated using the specific base station, the time for acquisition of the second position information can be eliminated.

The present invention successfully provides the mobile communication terminal capable of using the base station position information and the GPS position information more appropriately.

### BRIEF DESCRIPTION OF T HE DRAWINGS

FIG. 1 is an illustration showing a configuration of a cell phone as an embodiment of the present invention.

FIG. 2 is a flowchart showing an operation of the cell phone and a position information using method as an embodiment of the present invention.

### DESCRIPTION OF THE PREFERRED EMBODIMENTS

The expertise of the present invention can be readily understood in view of the following detailed description with reference to the accompanying drawings presented for illustrative purposes only. Subsequently, an embodiment of the present invention will be described with reference to the accompanying drawings. Identical portions will be denoted by the same reference symbols as much as possible, without redundant description.

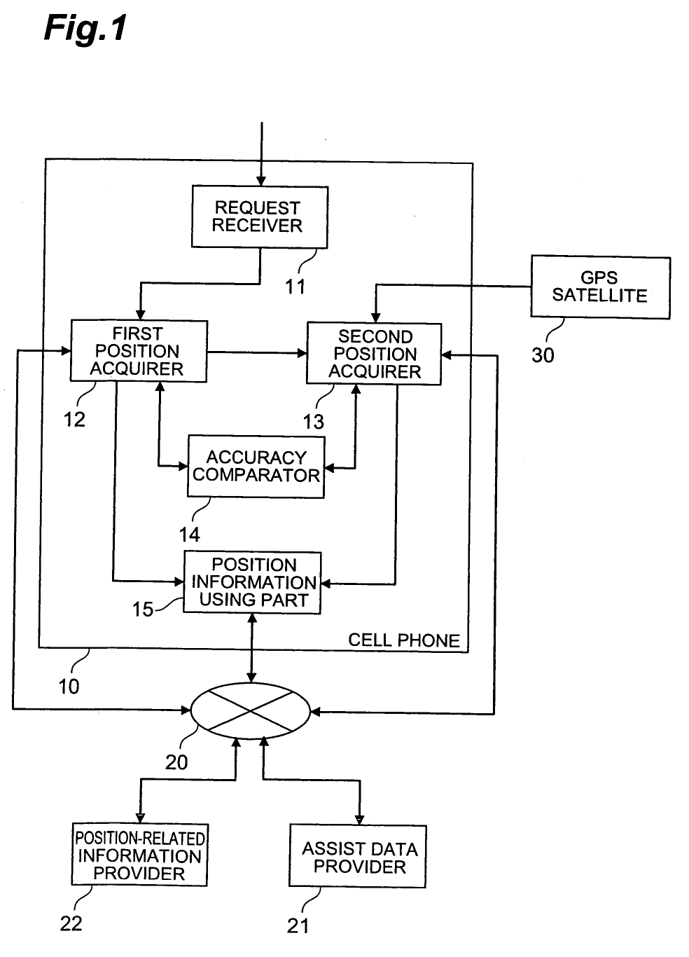

A cell phone of the present embodiment will be described with reference to FIG. 1. FIG. 1 is an illustration for explaining a configuration of cell phone 10 (mobile communication terminal).

The cell phone 10 is a mobile station capable of transmitting and receiving information as well as making a phone call, and in cell phone network 20 the cell phone 10 is placed under at least one base station. The cell phone 10 is able to calculate the position, based on data received through cell phone network 20 from assist data provider 21 and radio waves received from GPS satellites of the Global Positioning System (GPS) 30. Based on the acquired position information, the cell phone 10 is able to acquire position-related information through cell phone network 20 from position-related information provider 22 and to display the position-related information.

The cell phone 10 is, physically, an information communication device composed of elements such as a CPU, a memory, a power supply, a power amplifier, a frequency conversion chip, an antenna, and an input/output interface part.

The cell phone 10 is provided with the following functional components: request receiver 11, first position acquirer 12 (first position acquiring means), second position acquirer 13 (second position acquiring means), accuracy comparator 14 (accuracy comparing means), and position information using part 15 (position information using means). Subsequently, each of the components of the cell phone 10 will be described.

The request receiver 11 is a part that receives a request for position-related information. The position-related information is, for example, information such as geographical information around a place where the cell phone 10 is located. When receiving a request for position-related information, the request receiver 11 outputs reception information indicating the reception of the request for position-related information, to first position acquirer 12.

The first position acquirer 12 is a part that acquires first position information of cell phone 10 calculated using the position of at least one base station under which the cell phone 10 is placed, and error information indicating a horizontal error of the first position information. More specifically, when receiving the reception information from the request receiver 11, the first position acquirer 12 acquires the first position information from cell phone network 20 to which the cell phone 10 belongs. The first position acquirer 12 transmits and receives information to and from the cell phone network 20, physically, through transmitting/receiving means consisting of the aforementioned power amplifier, frequency conversion chip, antenna, and so on. The first position information is calculated using the electric field intensity of a radio wave from the base station, received by the cell phone 10, in the cell phone network 20 and the position of the base station. The first position acquirer 12 outputs the first position information thus acquired, to the position information using part 15.

Furthermore, the first position acquirer 12 determines whether the horizontal error of the first position information indicated by the acquired error information is within a predetermined error. For example, it determines whether the horizontal error of the first position information is not more than A [m]. Numerical value A is, for example, a number between 25 and 400. The horizontal error of the first position information calculated using an outdoor base station is normally not less than 400 [m]. On the other hand, the horizontal error of the first position information calculated using an indoor base station is about 25 [m]. Therefore, by setting the numerical value A between 25 and 400 and determining whether the horizontal error of the first position information is not more than A [m], it is feasible to determine whether the base station used in calculation of the first position information is one installed indoors or one installed outdoors.

When the result of the determination is that the horizontal error is larger than A [m], the first position acquirer 12 outputs information to request acquisition of the second position information, and the first position information to the second position acquirer 13. In addition, the first position acquirer 12 outputs the error information indicating the horizontal error of the first position information, to the accuracy comparator 14.

The second position acquirer 13 is a part that acquires second position information of cell phone 10 by making use of GPS, and error information indicating a horizontal error of the second position information. Acquisition of the second position information will be specifically described. The second position acquirer 13 acquires assist data from assist data provider 21. The second position acquirer 13 transmits and receives information to and from the cell phone network 20, physically, through transmitting/receiving means consisting of the aforementioned power amplifier, frequency conversion chip, antenna, and so on. The assist data is data specifying GPS satellites used in calculation of position, out of the twenty four GPS satellites around the earth. The second position acquirer 13 also receives ephemeris information from the GPS satellites. The ephemeris information is information containing orbit information and time information of each GPS satellite. The second position acquirer 13 performs GPS-based positioning. The GPS-based positioning is to specify GPS satellites necessary for positioning, based on the acquired assist data, and to calculate the latitude and longitude of the present location using the ephemeris information fed from the GPS satellites. The second position information is acquired through the GPS-based positioning.

The second position acquirer 13 outputs the error information indicating the horizontal error of the second position information, to the accuracy comparator 14. Furthermore, when receiving information indicating output of the second position information from the accuracy comparator 14, the second position acquirer 13 outputs the second position information to the position information using part 15.

The accuracy comparator 14 is a part that makes a comparison between respective accuracies of the first position information and the second position information, based on the error information indicating the respective horizontal errors in the first position information and the second position information. When the result of the comparison between the accuracies is that the horizontal error of the second position information is not more than the horizontal error of the first position information, the accuracy comparator 14 outputs the information indicating output of the second position information to the position information using part 15, to the second position acquirer 13.

The position information using part 15 is a part that first uses the first position information, irrespective of the result of the comparison made by the accuracy comparator 14, and thereafter uses position information with higher accuracy out of the first position information and the second position information in accordance with the result of the comparison made by the accuracy comparator. The use of the position information is, for example, such that the geographical information around the position indicated by the position information is acquired from the position-related information provider 22 and displayed on an unrepresented display part of cell phone 10. The use of the position information will be specifically described. The position information using part 15 transmits to the position-related information provider 22 the position information used, the error information indicating the horizontal error of the position information, and terminal identification information to identify the cell phone 10, whereupon the position-related information provider 22 sends back position-related information with the geographical information related to the position information, to the cell phone 10. The cell phone 10 displays the position-related information sent back by the position-related information provider 22, on a display screen.

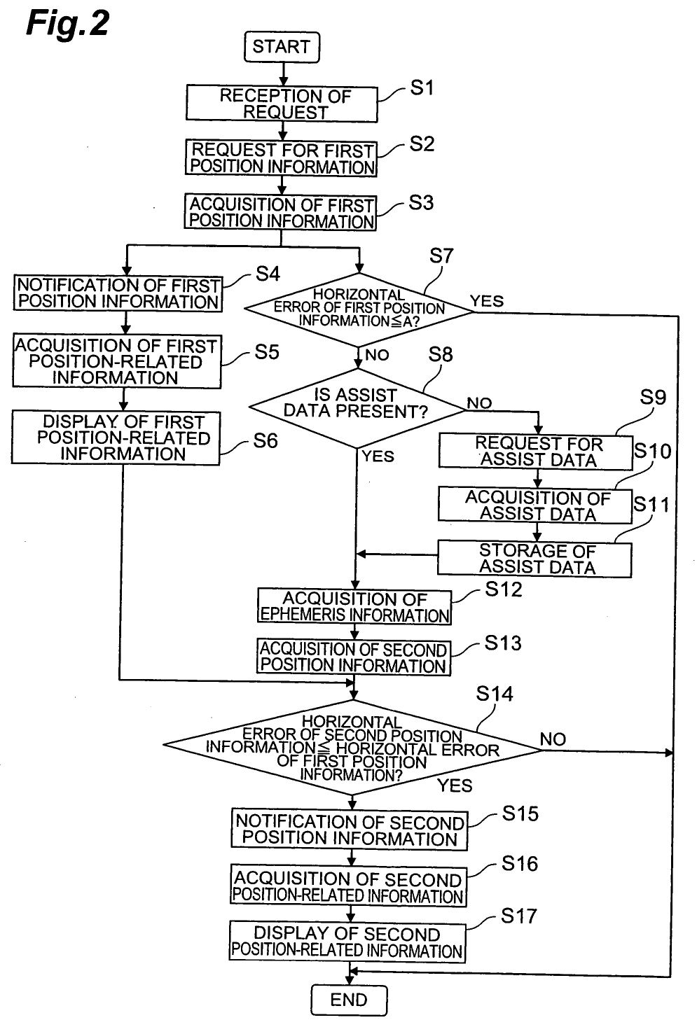

Subsequently, a position information using method will be described while describing the operation of the cell phone 10. FIG. 2 is a flowchart showing the operation of the cell phone 10.

The request receiver 11 receives a request for position-related information (S1). When the request for position-related information is received, the first position acquirer 12 sends a request for first position information, to the cell phone network 20 (S2). The first position acquirer 12 acquires from the cell phone network 20 the first position information and the error information indicating the horizontal error of the first position information (S3).

After the acquisition of the first position information, the position information using part 15 notifies the position-related information provider 22 of the first position information, the error information of the first position information, and the identification information of cell phone 10 (S4). The position information using part 15 acquires first position-related information generated according to the information thus notified of, by the position-related information provider 22 (S5). After the acquisition of the first position-related information, the position information using part 15 displays the first position-related information (S6).

After the acquisition of the first position information, the first position acquirer 12 determines whether the horizontal error of the first position information is not more than a predetermined value A [m] (S7). When the horizontal error of the first position information is not more than the predetermined value A [m] (YES at S7), the sequential operation is terminated. For example, let us explain a specific case where the predetermined value is 100 [m] and where the horizontal error of the first position information is 25 [m]. In general, where the first position information is calculated using the position of an indoor base station, the horizontal error of the first position information is about several ten meters. On the other hand, where the first position information is calculated using the position of an outdoor base station, the horizontal error of the first position information is a value of not less than 400 [m]. When the horizontal error of the first position information is 25 [m] as described above, the cell phone 10 is located indoors, because the first position information is calculated using the position of an indoor base station. Since the cell phone 10 is unable to acquire the ephemeris information from GPS satellites indoors, the second position information is not available. Therefore, the sequential operation is terminated, so as to eliminate the time necessary for acquisition of the second position information.

When the horizontal error of the first position information is larger than the predetermined value A [m] (NO at S7), the second position acquirer 13 determines whether there is effective assist data stored (S8). When there is effective assist data (YES at S8), the second position acquirer 13 acquires the ephemeris information (S12).

On the other hand, when there is no effective assist data (NO at S8), the second position acquirer 13 sends information indicating a request for assist data, to the assist data provider 21 (S9). In accordance with the request for assist data, the second position acquirer 13 acquires the assist data provided by the assist data provider 21 (S10). The second position acquirer 13 stores the assist data thus acquired (S11). After the assist data is stored, the second position acquirer 13 acquires the ephemeris information (S12).

After acquisition of the ephemeris information, the second position acquirer 13 acquires the second position information and the error information of the second position information (S13). After acquisition of the horizontal error of the second position information, the accuracy comparator 14 makes a comparison between the horizontal error of the second position information and the horizontal error of the first position information (S14). When the horizontal error of the second position information is larger than the horizontal error of the first position information (NO at S14), the sequential operation is terminated. When the horizontal error of the second position information is not more than the horizontal error of the first position information (YES at S14), the position information using part 15 notifies the position-related information provider 22 of the second position information, the error information of the second position information, and the identification information of cell phone 10 (S15). The position information using part 15 acquires second position-related information generated according to the information thus notified of, by the position-related information provider 22 (S16). After acquisition of the second position-related information, the position information using part 15 displays the second position-related information by switching the first position-related information thereto (S17).

Subsequently, the action and effect of the present embodiment will be described. Since the first position information or the second position information is selectively used in accordance with the result of the comparison between the horizontal errors, the embodiment provides the mobile communication terminal capable of using the base station position information and the GPS position information more appropriately.

The above embodiment was configured not to acquire the second position information when the horizontal error of the first position information was within the predetermined error. However, it is also possible to adopt a configuration wherein when the base station used in the calculation of the first position information is a specific base station, the first position information contains information about the specific base station, and the acquisition of the second position information is not carried out. For example, supposing a base station installed indoors is the specific base station, the first position information is calculated using the base station installed indoors, and in that case the second position information is not acquired. Since the cell phone 10 is unable to acquire the second position information indoors, it can eliminate the time necessary for acquisition of the second position information.

The cell phone network 20 in the present embodiment does not embrace only cell phone networks of the so-called PDC system and W-CDMA system, but also embraces networks available for IP cell phones and networks available for Bluetooth (registered trademark) cell phones. Therefore, the base stations in the cell phone network 20 include wireless LAN base stations and Bluetooth (registered trademark) base stations.

What is claimed is:

1. A mobile communication terminal comprising:
first position acquiring means for acquiring first position information of the mobile communication terminal calculated using a position of at least one base station under which the mobile communication terminal is placed;
second position acquiring means for acquiring second position information of the mobile communication terminal, using the global positioning system;
accuracy comparing means for making a comparison between respective accuracies of the first position information and the second position information; and
position information using means for selectively using the first position information or the second position information in accordance with a result of the comparison;
wherein the position information using means first uses the first position information, irrespective of the result of the comparison made by the accuracy comparing means, and, thereafter,
uses position information with higher accuracy out of the first position information and the second position information in accordance with the result of the comparison made by the accuracy comparing means.

2. The mobile communication terminal according to claim 1, wherein each of the first position information and the second position information contains error information indicating a horizontal error, and
wherein the accuracy comparing means makes the comparison between the accuracies on the basis of the error information contained in each of the first position information and the second position information.

3. The mobile communication terminal according to claim 1, wherein when a horizontal error of the first position information indicated by error information contained in the first position information is within a predetermined error,
the second position acquiring means does not acquire the second position information.

4. The mobile communication terminal according to claim 1, wherein when the base station used in calculation of the first position information is a specific base station, the first position information contains information about said specific base station, and
wherein the second position acquiring means does not acquire the second position information.

5. A position information using method comprising:
a step wherein first position acquiring means acquires first position information of a mobile communication terminal calculated using a position of at least one base station under which the mobile communication terminal is placed;
a step wherein second position acquiring means acquires second position information of the mobile communication terminal, using the global positioning system;
a step wherein accuracy comparing means makes a comparison between respective accuracies of the first position information and the second position information;
a step wherein position information using means selectively uses the first position information or the second position information in accordance with a result of the comparison; and
a step wherein the position information using means first uses the first position information, irrespective of the result of the comparison made by the accuracy comparing means, and, thereafter,
uses position information with higher accuracy out of the first position information and the second position information in accordance with the result of the comparison made by the accuracy comparing means.
